(19) United States
(12) Patent Application Publication
(10) Pub. No.: US 2017/0221082 A1
(43) Pub. Date: Aug. 3, 2017

(54) Systems and Methods of Creating, Conducting and Compiling Results of Surveys

(71) Applicants: Scott Fulton Murray, Manotick (CA); Brent Allen Claxton, Kemptville (CA); Jeff Bennett, Ottawa (CA); Peter Haighton, Ottawa (CA)

(72) Inventors: Scott Fulton Murray, Manotick (CA); Brent Allen Claxton, Kemptville (CA); Jeff Bennett, Ottawa (CA); Peter Haighton, Ottawa (CA)

(21) Appl. No.: 15/289,124

(22) Filed: Oct. 7, 2016

Related U.S. Application Data
(60) Provisional application No. 62/239,710, filed on Oct. 9, 2015.

(51) Int. Cl. G06Q 30/02

(52) U.S. Cl. CPC G06Q 30/0203

(57) ABSTRACT

The present invention provides for a system and method for creating, conducting and compiling the results of a survey. The system includes a backend platform and a user device having a related mobile application. The backend platform has at least one memory that stores computer-executable instructions and at least one processor configured to access the at least one memory. The processor is configured to create at least one channel and associated a target audience with that channel. The processor is also configured to create at least one survey and also associate the survey with the channel. The processor is also configured to associate at least one participant having a user device with the one channel. The survey is deployed to the participant once specific time and location criteria associated with the survey has been met. The location criteria can be met through the use of a physical location determination device. Once the participant responses to the survey, the results are provided to the backend platform.

### REFERENCE TO PENDING APPLICATIONS

This application claims the benefit of pending U.S. Patent Provisional Application, Ser. No. 62/239,710 filed on Oct. 9, 2015.

### REFERENCE TO MICROFICHE APPENDIX

This application is not referenced in any microfiche appendix.

### BACKGROUND OF THE INVENTION

Field of the Invention

The present invention is generally directed toward conducting surveys, and more particularly to conducting surveys utilizing mobile technology.

Background

Known systems and methods of creating, conducting and compiling the results of surveys impose a significant time lag between identifying a need to gather opinion and the actual gathering and compilation of opinions.

Examples of existing methods and systems of gathering opinion data include using web surveys, phone surveys, social network feedback mechanisms, and, focus groups (for example).

Each of these types of methods and systems exhibits various shortcomings. Traditional web survey misses an opt-in where people agree to provide opinions on their areas of interest. This diminishes the significant of any provided data. Also, traditional web survey requires lengthy setup and results compilation times.

Phone survey, due to its requirement for human labour, comes at substantial financial and chronological costs. Due to such costs, sample sizes are typically kept rather small, in comparison to automated, non-phone surveys. Further, phone surveys are generally of randomized samples, which do not reflect the respondents' preference for contact or content. Automated phone surveys require less human labour; however, participation rates are low, and the randomness issue is not addressed.

Social network feedback lacks the rigour necessary to properly analyze the feedback. Often times it requires mining significant amounts of comments with automated algorithms that may or may not be properly determining sentiment. Further, the sheer volume of data can result in front end time delays as well as the need for determinations as to which data should be considered in a given situation. These determinations take time and can heavily influence output.

Focus groups require a significant investment in human labour and, thus, cost, to establish and facilitate. Due to these costs, sample sizes are typically quite small. Achieving statistically significant samples representing different demographic groups may require establishing and facilitating numerous focus groups at immense time and cost. In any application wherein there is a need for prompt feedback, use of focus groups is impractical.

Accordingly, there is a need for a system that uses mobile technology to allow a user to request immediate response to questions from a broad audience (defined as those with the application installed).

### BRIEF SUMMARY OF THE INVENTION

The present invention satisfies the needs discussed above. The present invention is generally directed toward conducting surveys, and more particularly to conducting surveys utilizing mobile technology.

For purposes of this application, the term “survey” shall mean one or more questions aimed at extracting specific data from the general public or a specific group of people, which can be referred to as a target audience.

In general, herein is disclosed a system wherein, upon issuance of a survey, those members of the target audience, also referred to as participants, with an associated mobile application will be notified of the survey once specific time and location criteria have been met and prompted to provide a response. The system may also be enhanced to support automated or manually generated reminder messages to those invited to participate to further drive responses. Incentives, such as a points system may also be provided as an award for responses. These points may simply show achievement or may be redeemed for goods and/or services. The time between invitation to respond and response may be used in calculating points awarded. For example, it may be that the highest number of points is awarded in the first minutes after invitation with a declining number of points awarded as time goes on.

To help ensure the quality of responses, the system can provide a survey only to a specific list of identified responders, to all responders who have identified an interest in the survey's topic or to the general public. The lists of responders can be compiled and retained.

This system overcomes the issues of existing solutions to opinion gathering by providing a broad yet targetable audience, using ubiquitous technology to allow for an immediate connection between the person asking the question and the audience; and, achieving a much lower price per opinion than other immediate, directly connected options such as phone survey

In one aspect of the present invention, a system for conducting a survey is disclosed. This aspect includes a backend platform having at least one memory that stores computer-executable instructions and at least one processor configured to access the at least one memory. The processor is configured to execute the computer-executable instructions to perform various operations.

In this aspect, these operations include the creating a channel and to identify a target audience associated with the channel. This embodiment refers to a single channel. This is illustrative. Those skilled in the art will recognize that the creation of multiple channels is within the scope this invention. The channel is a conduit for the target audience to gain access to surveys having a specific commonality. Channels can be based on a particular subject, such as sports, travel or business or based on a particular experience, such as a visit to an amusement park, a specific airline flight, or a visit to a retail shop. While these examples are illustrated, those skilled in the art will recognize that these examples are not limiting and that other categories of surveys are within the scope the present invention.

Further, the operations of this aspect includes the creating of at least one survey. This survey is associated with at least one channel, along with the specific time and location criteria for the deployment of the survey. The creation of the channels and surveys can be performed through input by a user of the system who has the intention to create surveys. This user can be referred to an Administrator.

Further, the operations of this aspect includes associating at least one participant with the at least one channel via the participant's user device. This user device can be a smartphone, tablet or other mobile communication device. This association is established through the use of a user device software application, referred to as a mobile app. This mobile app allows the participant to select specific channels in order to receive the surveys on topics of interest as categories by the channels. By selecting a channel, the participant is granting permission for the surveys associated with the channel to be provided to the participant's user device. These surveys can be provided to the user device through a push notification process.

Further, the operations of this aspect includes deploying survey to the participant, over a wireless network, specific time and location criteria has been met. This allows the survey to deployed immediately or at a later time. Regarding the specific time criteria, the time criteria can be administrative based, which allows for the availability of the survey to be deployed immediately after creation or at some time in the future. Further, the time criteria may also be location based, which once the location criteria has been satisfied allows for a deployable survey to be deployed either immediately or at some time in future.

The location criteria can be satisfied by the use of a physical location determination device. In this aspect, the physical location determination device is based on Bluetooth low energy technology. One such device is the iBeacon™. This is illustrative and not meant to be limiting. The physical location determination device allows for the specific location of a participant to be determined. Once the user device is in wireless communication with the physical location determination device, the mobile app can take specific actions based on a unique identifier of the physical location determination device. These actions can include communicating with the backend platform, provide the participant with specific information or present a survey to the participant. In this aspect, the actions taken by the mobile app upon entering into the signal range of the physical location determination device is to communicate with the backend platform where the specific actions for the mobile app based on the device's unique identifier are stored in the database of backend platform. The backend platform can then implement the necessary action to take, such as sending a survey, a notification or providing other information to the mobile app.

In combination, the utilization of time and location, the deployment of a survey can take on many configurations. For example, when a participant enters into a specific location, a survey can be immediately deployed to the participant's user device. Additionally, when a participant enters or leaves a specific location, a survey can be deployed on a time-delayed basis.

Still further, the operations of this aspect include the receiving of the responses from the participant by the processor. These responses are immediately provided to the processor for further analytical evaluation.

As an example, a participant has chosen to receive surveys from an amusement park. When the participant enters the amusement park, a physical location determination device located at the exit of a roller coaster within the amusement park communicates with the mobile app which in turn communicates with the processor. A survey regarding the participant's experience on that roller coaster will be provided to the participant through a push notification. This survey can include various questions such as overall experience, wait times, etc. Further, upon exiting the amusement park, a physical location determination device located at the exit communicates with the mobile app which again trigger a customer experience based survey to be provided to the participant. This survey can be provided either immediately, at a later time or both. This system allows for immediate and delayed feedback.

In another aspect of the present invention, a method for conducting a survey is disclosed. This aspect includes creating at least one channel, identifying a target audience associated with each channel, creating at least one survey which is associated with at least one channel, associating specific time and location criteria for the deployment of each survey, associating at least one participant having a user device with a channel, deploying over a wireless network the survey to the participant when the specific time and location criteria has been met and receiving responses from the user device from each of the at least one participant.

The invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a block diagram of an embodiment of the system of the present invention.

FIG. 2 is a flow diagram of an embodiment of the method of the present invention.

FIG. 3 is a flow diagram of an additional embodiment of the method of the present invention.

### DESCRIPTION OF THE INVENTION

The present invention satisfies the needs discussed above. The present invention is generally directed toward conducting surveys, and more particularly to conducting surveys utilizing mobile technology.

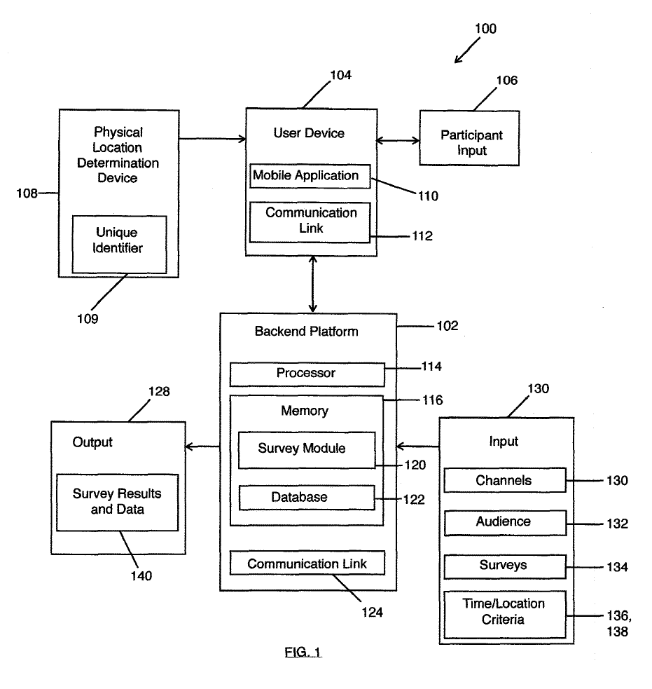

As shown in FIG. 1, an embodiment 100 of the system of the present invention is illustrated. This embodiment comprises a backend platform 102 and a user device 104. In this embodiment, the inclusion of a single user device 104 is illustrative. Those skilled in the art will recognize that multiple user devices are within the scope of the present invention. Backend platform 102 is in two-way communication with user device 104 through communication links 112, 124. Backend platform 102 includes a processor 114 and a memory 116 and can be a computer, smartphone, or other similar apparatus. Further, backend platform can include multiple processors and/or multiple memory. Still further, backend platform 102 can reside in a local computer and/or be located in a cloud server for remote access over the Internet. Memory 116 includes a survey module 120 and a database 122. Survey module 120 includes the computer-executable instructions and software programming for backend platform 102. Database 122 stores the data that is required to operate the backend platform 102 and to perform the related various operations.

In this embodiment 100, user device 104 includes a mobile application 110 and communication link 112. User device 104 further receives input from a participant 106 and from a physical location determination device 108. Mobile app 110 includes software programming that, upon communication from physical location determination device 108 and/or input from participant 106, communicate with backend platform 102.

In this embodiment 100, processor 114 is configured to access memory 116 and is configured to execute the computer-executable instructions and software programming within the survey module 120 to perform various operations. Processor 114 received input 126 from a backend user, which can be referred to as an Administrator, in order to create at least one channel 130, a target audience 132 associated with channel 130 and at least one survey 134 associated with channel 130. Further, processor 114 is configured to perform the various operations relating to time and location criteria 136, 138 associated with survey 134 and related to the deployment of the survey 134.

Time criteria 136 can be administrative based, which allows for the availability of survey 134 to be deployed immediately after creation or at some time in the future. Further, time criteria 136 may also be location based, which once location criteria 138 has been satisfied allows for a deployable survey 134 to be deployed either immediately or at some time in future.

In this embodiment 100, user device 104 includes a mobile application 110 and communication link 112. User device 104 further receives input from the participant 106 and from a physical location determination device 108. Mobile app 110 includes software programming that, upon communication from physical location determination device 108 and/or input from participant 106, communicate with backend platform 102.

Physical location determination device 108 assists with establishing and determining when location criteria 138 for the survey 134 has been met. In this embodiment, physical location determination device is based on Bluetooth low energy technology and has a unique identifier 109. One such device is the iBeacon™. This is illustrative and not meant to be limiting. In this embodiment, when the participant 106 enters into range of the physical location determination device 108, mobile app 110 communicates with physical location determination device 108. The range of the physical location determination 108 device can be pre-set or customized by the Administration when either a channel 130 or survey 134 is created. Further, the range can modified after the creation of a channel 130 or survey 134. Upon such communication, mobile app 110 then communicates with backend platform 102 where specific actions for the mobile app based on the device's unique identifier are stored in the database 122 of backend platform 102. Backend platform 102 can then implement the necessary action to take, such as sending a survey 134, a notification or providing other information to the mobile app 104. In addition, mobile app 104 can then implement those specific actions received from backend platform 102.

Once the time and location criteria 136, 138 has been met, processor 114 deploys survey 134 to user device 104. Once participant 106 responds to survey 134, the results 140 are provided to backend platform 102. Results 140 can be analyzed by backend platform 102 with the results being provided as output 128 or can be provided in a raw, non-analyzed format, or a combination of both. In this embodiment, the results are provided once all the responses from the participants have been received. However, this is merely illustrative and those skilled in the art will recognize this is not meant to be limiting. In other embodiments, the results can be provided in a real-time, instant feedback manner. This can occur when the results are received from participants over a length of time.

In this embodiment, both user device 104 and backend platform 102 comprise a number of graphical user interface elements. This is illustrative and those skilled in the art will recognize this is not meant to be limiting. In other embodiments, both the user device 104 and backend platform 102 can include integration with voice recognition/personal assistant technology to allow direct speech support for application functions (such as creating channels, creating surveys, subscribing to channels, responding to questions, etc.).

In this embodiment, backend platform 102 is configured to include standard computer components. This is illustrative and those skilled in the art will recognize this is not meant to be limiting. In other embodiments, the backend platform may include software located partially or fully within an mobile application to further facilitate the backend platform functions (such as creating channels, creating surveys, etc.).

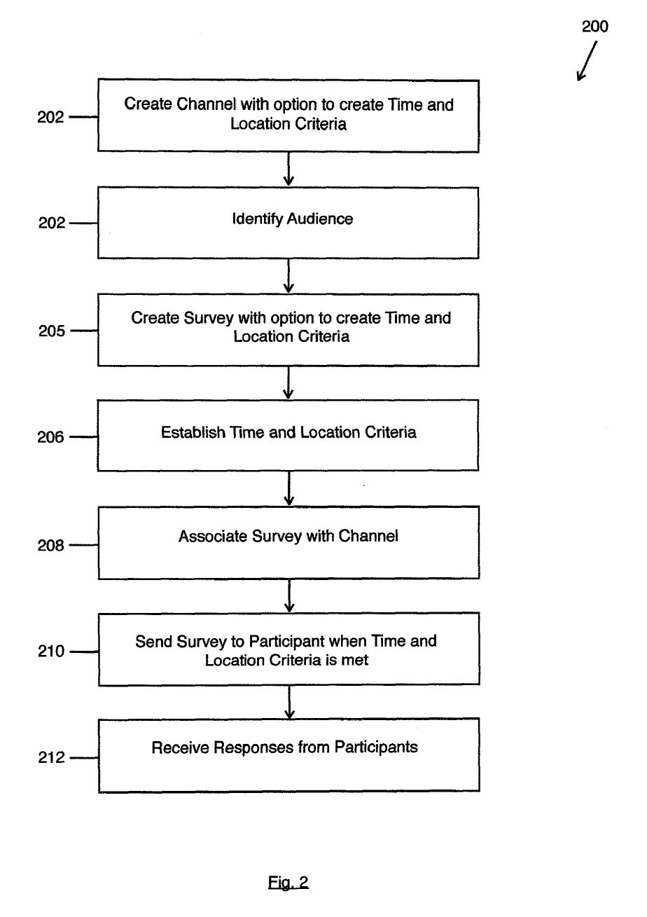

As shown in FIG. 2, an embodiment 200 of the method of the present invention is illustrated. This embodiment is directed toward the backend platform 102 and comprises the steps of creating at least one channel 202, identifying target audience associated with the channel 204, creating at least one survey associated with the channel 205, associating specific time and location criteria for the deployment to the survey 206, associating at least one participant having a user device with the channel 208, deploying the survey over a wireless network to the participant when the specific time and location criteria has been met 210 and receiving responses from the user device of the participant 212.

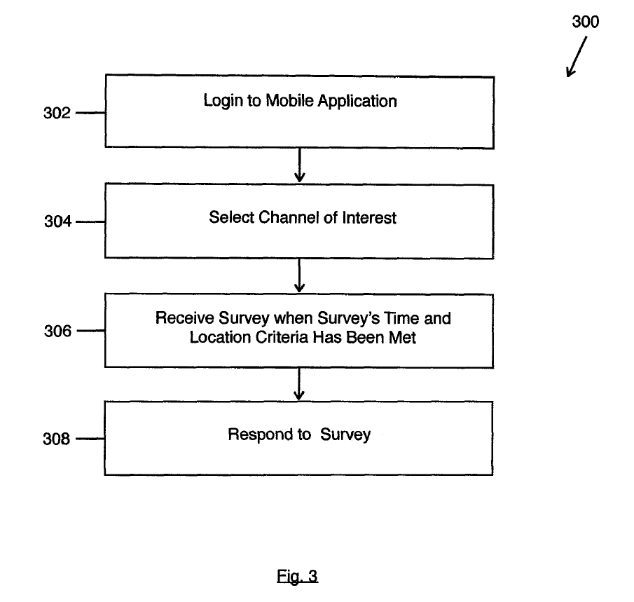

As shown in FIG. 3, an embodiment 300 of the method of the present invention is illustrated. This embodiment is directed toward the participant 106 and user device 104 and comprises the steps of logging in to the mobile application 302, selecting a channel of interest 304, receiving a survey when the survey's time and location criteria have been met 306, responding to the survey 308. In this embodiment, once user device 104 is in communication with physical location determination device 108, mobile application 110 communicates with backend platform 102. Backend platform 102 sends instructions to mobile application 110 to perform specific actions, such as download survey immediately, download survey on a time delayed basis or not to download any survey.

The mobile application user and the administrator steps are necessarily discreet. Participants may identify areas of interest at any time, such that some aspects of the method are fluid in nature, and highly responsive. Administrators may create channels and publish surveys at any time.

In another embodiment, should a participant subscribe to a channel (as discussed hereinabove) with published active surveys, the participant may only receive those active surveys and not receive a retroactive notifications of surveys. They will, however, receive a notification for all new questions published after subscription.

In another embodiment, backend platform and mobile applications may be expanded to allow non administrators to contribute surveys for topics. These contributions would be reviewed by the administrator to ensure quality before they are distributed to the channel audience.

In another embodiment, backend platform and mobile applications may be extended to allow better categorization/targeting of content based on demographics, peer recommendations, and other algorithms. This could be used in a direct marketing context to expand and monetize audiences.

In another embodiment, backend platform and mobile applications may be extended to allow better monetization of the user base such as paid promotion of channels, enhanced analytics, advanced targeting/sampling.

In another embodiment, backend platform and mobile applications, the channels, surveys and notifications may be enhanced to include multimedia content such as videos to support questions, audio responses, etc.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

While various embodiments in accordance with the principles disclosed herein have been described above, it should be understood that they have been presented by way of example only, and are not limiting. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided as organizational cues. These headings shall not limit or characterize the invention(s) set out in any claims that may issue from this disclosure. Specifically and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

The use of the word “a” or “an” when used in conjunction with the term “comprising” in the claims and/or the specification may mean “one,” but it is also consistent with the meaning of “one or more”, “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this disclosure and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, un-recited elements or method steps. Methods herein described are exemplary, and performance is intended by software (e.g., stored in memory and/or executed on hardware), hardware, or a combination thereof. Hardware modules may include, for example, a general-purpose processor, and/or analogous equipment. Software modules (executed on hardware) may be expressed in a variety of coded software languages comprising object-oriented, procedural, or other programming language and development tools.

Some embodiments described herein relate to devices with a non-transitory computer-readable medium (also can be referred to as a non-transitory processor-readable medium or memory) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to storage media and hardware devices that are specially configured to store and execute program code.

All of the systems and/or methods disclosed and claimed herein can be made and executed without undue experimentation in light of the present disclosure. While the compositions and methods of this disclosure have been described in terms of preferred embodiments, it will be apparent to those of skill in the art that variations may be applied to the compositions and/or methods and in the steps or in the sequence of steps of the method described herein without departing from the concept, spirit and scope of the disclosure. All such similar substitutes and modifications apparent to those skilled in the art are deemed to be within the spirit, scope and concept of the disclosure as defined by the appended claims

1. A system for conducting a survey comprising:
at least one memory that stores computer-executable instructions;
at least one processor configured to access the at least one memory, wherein the at least one processor is configured to execute the computer-executable instructions to perform operations comprising:
creating at least one channel;
identifying target audience associated with each of the at least one channel;
creating at least one survey, the at least one survey associated with the one of the at least one channel;
associating specific time and location criteria for the deployment to each of the at least one survey;
associating at least one participant with the at least one channel, each at least one participant being associated with a respective user device;
deploying each of the at least one survey, over a wireless network, to the associated at least one participant when the specific time and location criteria has been met; and
receiving, by the at least one processor, responses from the user device from each of the at least one participant.

2. The system of claim 1, wherein the target audience is the general public.

3. The system of claim 1, wherein the target audience is private group of participants.

4. The system of claim 1, wherein each of the surveys associated with each of the at least one channel has at least one commonality.

5. The system of claim 1, wherein the determination that the location criteria has been met is based on a physical location determination device.

6. The system of claim 5, wherein the physical location determination device is based on Bluetooth low energy technology.

6. The system of claim 1, wherein the deploying of each of the at least one survey is performed by push notification to the respective user device.

7. The system of claim 1, wherein the user devices comprise a number of graphical user interface elements.

8. A method for conducting a survey comprising:
creating at least one channel;
identifying target audience associated with each of the at least one channel;
creating at least one survey, the at least one survey associated with the one of the at least one channel;
associating specific time and location criteria for the deployment to each of the at least one survey;
associating at least one participant with the at least one channel, each at least one participant being associated with a respective user device;
deploying each of the at least one survey, over a wireless network, to the associated at least one participant when the specific time and location criteria has been met; and
receiving, by the at least one processor, responses from the user device from each of the at least one participant.

9. The method of claim 8, wherein the target audience is the general public.

10. The method of claim 8, wherein the target audience is private group of participants.

11. The method of claim 8, wherein each of the surveys associated with each of the at least one channel has at least one commonality.

12. The method of claim 8, wherein the determination that the location criteria has been met is based on a physical location determination device.

13. The method of claim 8, wherein the deploying of each of the at least one survey is performed by push notification to the respective user device.
